(19) United States
(12) Patent Application Publication
(10) Pub. No.: US 2009/0108068 A1
(43) Pub. Date: Apr. 30, 2009

(54) Parallax adjustment in imaging readers for electro-optically reading indicia

(76) Inventor: Igor Vinogradov, New York, NY (US)

Correspondence Address: KIRSCHSTEIN, ISRAEL, SCHIFFMILLER & PIERONI, P.C., 425 Fifth Avenue, 5TH FLOOR, New York, NY, 10016-2223, US

(21) Appl. No.: 11/981,462

(22) Filed: Oct. 31, 2007

(51) Int. Cl. G06K 7/10

(52) U.S. Cl. 235/462.21

(57) ABSTRACT

In an imaging reader for reading a target located in a range of working distances from the reader, a solid-state imager captures light from the target in the range of working distances over a field of view, an aiming system visually illuminates the symbol with an aiming light pattern, and a steering system steers the aiming light pattern and/or the field of view to be substantially aligned throughout the range of working distances to aid an operator in aiming the imager at the symbol prior to reading.

### BACKGROUND OF THE INVENTION

Optical codes or dataforms are patterns made up of image areas having different light-reflective or light-emissive properties, which are typically assembled in accordance with a priori rules. The optical properties and patterns of codes are selected to distinguish them in appearance from the background environments in which they are used. Electro-optical readers identify or extract data from codes and are used in both fixed or portable installations in many diverse environments such as in stores for check-out services, in manufacturing locations for work flow and inventory control, and in transport vehicles for tracking package handling. The code is used as a rapid, generalized means of data entry.

Many conventional readers are designed to read one-dimensional bar code symbols. The bar code symbol is a pattern of variable-width rectangular bars separated by fixed or variable width spaces. The bars and spaces have different light-reflecting characteristics. One example of a one-dimensional bar code symbol is the UPC/EAN code used to identify, for example, product inventory. An example of a two-dimensional or stacked bar code symbol is the PDF417 barcode, which is disclosed in U.S. Pat. No. 5,635,697. Another conventional code is known as “MaxiCode”, which consists of a central finder or bull's eye center and a grid of hexagons surrounding the central finder. It should be noted that the aspects of the inventions disclosed in this patent application are applicable to optical code readers, in general, without regard to the particular type of optical codes that they are adapted to read.

Many conventional readers are handheld and generate one or more moving beams of laser light that sweep one or more scan lines across a symbol that is located anywhere in a range of working distances from a reader. The reader obtains a continuous analog waveform corresponding to the light reflected or scattered from the symbol. The reader then decodes the waveform to extract information from the symbol. A reader of this general type is disclosed, for example, in U.S. Pat. No. 4,251,798. A reader for detecting and decoding one-and two-dimensional symbols is disclosed in U.S. Pat. No. 5,561,283.

Symbols can also be read by employing solid-state imagers in imaging readers, also often deployed in handheld housings. For example, an imager, akin to that used in a digital camera, may have a one- or two-dimensional array of cells or pixel sensors that correspond to image elements or pixels in a field of view of the imager. Such an imager may be a one- or two-dimensional charge coupled device (CCD) or a complementary metal oxide semiconductor (CMOS) device, and associated circuits for producing electronic signals corresponding to the one- or two-dimensional array of pixel information over the field of view.

It is therefore known to use a CCD for capturing a monochrome image of a bar code symbol to be read as, for example, disclosed in U.S. Pat. No. 5,703,349. It is also known to use a CCD with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

Although generally satisfactory for its intended purpose, the use of an imaging reader is often frustrating, because an operator cannot tell whether the imager, or the handheld housing in which the imager is mounted, is aimed directly at the target symbol, which can be located anywhere within a range of working distances from the reader. Contrary to moving laser beam readers in which an operator can see the visible laser beam as at least one scan line on the symbol, the imager is a passive unit and provides no visual feedback to the operator to advise where the imager is aimed.

To alleviate such problems, the prior art proposed in U.S. Pat. No. 6,060,722 an aiming light pattern generator in an imaging reader, for generating an aiming light pattern on the symbol prior to reading. This known generator utilizes a diffractive optical element (DOE), a holographic element, or a Fresnel element, which generates a light interference pattern useful for framing the field of view. It is also known to use non-interferometric optical elements to project an aiming line as described in U.S. Pat. No. 6,069,748, which disclosed the use of a toroidal lens to project a single aiming line to guide a cutting tool. U.S. Pat. No. 7,182,260 disclosed the use of a refractive optical element (ROE) having a plurality of refractive structures to generate a light pattern on a symbol for framing the field of view of an imager.

However, the known aiming light pattern generator is offset from the imager and produces a parallax error, because the aiming light pattern generator generates an aiming light pattern that is not centered in the field of view of the imager throughout the range of working distances. This makes it quite confusing for the operator to accurately aim the reader at the symbol that can be located anywhere within the range of working distances. Some long symbols may not be read, because they extend beyond the field of view at one end and have an extra margin at its opposite end. Long symbols have to be accurately aligned within the field of view.

More particularly, as shown in the prior art reader of FIG. 3, an imaging system comprising an imaging lens 1 and an imager 2 has an imaging axis 7 centered in a field of view. The imaging lens 1 is operative for imaging a target 3 on the imager 2. An aiming light system comprising a pattern generator 5 has an aiming light axis 6 and projects an aiming light pattern on the target 3. The aiming light pattern consists of a central cross 4a, which shows a center of the aiming light pattern, and a plurality of framing corner lines 4b, 4c, 4d, and 4e, which shows four corners of, and frames, the aiming light pattern. There is a parallax “S” between the axes 6 and 7 of the aiming and the imaging systems. An operator that wishes to operate a reader to read the target 3 at a working distance “Z” is led to believe that the center of the field of view is at the central cross 4a, whereas, in fact, the center of the field of view is at a point 4a′ on the imaging axis 7. Sometimes, the aiming light pattern is tilted with respect to the imaging axis. In this event, the aiming light pattern and the field of view are aligned at a single working distance, but not at any of the other working distances. This makes it even more confusing for the operator to properly aim the reader at the other working distances. Accurate aiming of the reader at the symbol that can be located anywhere within the range of working distances thus cannot be assured.

### SUMMARY OF THE INVENTION

One feature of the present invention resides, briefly stated, in an imaging reader for, and a method of, electro-optically reading a target, such as one-dimensional or two-dimensional bar code symbols, located in a range of working distances from the reader. An imaging system including a solid-state imager having an array of image sensors is operative for capturing light from the target symbol in the range of working distances over a field of view. Such an imager may be a one- or two-dimensional charge coupled device (CCD) or a complementary metal oxide semiconductor (CMOS) device. An aiming system includes an aiming light pattern generator for visually illuminating the symbol with an aiming light pattern prior to reading.

In accordance with one aspect of this invention, a steering system is operative for steering at least one of the aiming light pattern and the field of view to be substantially aligned with respect to each other throughout the range of working distances to aid an operator in aiming the imager at the symbol prior to reading. Thus, the aiming light pattern can be steered to be substantially centered in the field of view, or the field of view can be steered to be substantially centered in the aiming light pattern, or both the aiming light pattern and the field of view can be steered until they are in mutual substantial alignment. This steering enables the operator to accurately aim the reader at the symbol that can be located anywhere within the range of working distances.

Preferably, the imaging system includes an imaging lens for imaging the light from the symbol onto the imager along an imaging axis substantially centered in the field of view, and the aiming system illuminates the symbol along an aiming axis substantially centered in the aiming light pattern. The steering system is operative for moving the at least one of the aiming light pattern and the field of view until the aiming axis substantially intersects the imaging axis at each working distance.

It is advantageous if the steering system includes a controller operatively connected to the imaging and the aiming systems. The steering system is operative for controlling the imaging system to acquire an image of the aiming light pattern during aiming to generate a control signal, and for steering the at least one of the aiming light pattern and the field of view in response to the control signal. Preferably, the controller is also operative for processing the light captured from the symbol during reading into data relating to the symbol.

In accordance with one embodiment of this invention, the steering system includes a liquid-filled cell bounded by light-transmissive windows oriented at a window angle relative to each other. The at least one of the aiming light pattern and the field of view passes through, and is refracted in, the cell at an angle of refraction. A drive is operative for changing the window angle and, in turn, the angle of refraction in response to the control signal.

In accordance with another embodiment of this invention, the steering system includes an acousto-optical light deflector through which the at least one of the aiming light pattern and the field of view passes at a deflection angle. An acoustic drive is operative for changing the deflection angle in response to the control signal.

In accordance with yet another embodiment of this invention, the steering system includes a variable liquid electro-wetting element having a liquid whose shape changes in response to an applied voltage. The change in shape causes the at least one of the aiming light pattern and the field of view passing through the liquid to deflect at a deflection angle. A voltage source or drive is operative for changing the deflection angle in response to the applied voltage.

The aiming light pattern preferably comprises a visible center mark substantially centered in the aiming light pattern, and a plurality of visible corner marks that frame corners of the aiming light pattern. Other aiming light patterns, including a single light spot or a scan line, are within the scope of this invention.

Another feature of the present invention resides, briefly stated, in the method of electro-optically reading a symbol located in a range of working distances from an imaging reader. The method includes performing the steps of capturing light from the symbol in the range of working distances with a solid-state imager having an array of image sensors over a field of view; visually illuminating the symbol with an aiming light pattern generated by an aiming system; and steering at least one of the aiming light pattern and the field of view to be substantially aligned relative to each other throughout the range of working distances to aid an operator in aiming the imager at the symbol prior to reading.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a point-of-transaction workstation including an imaging reader operative for capturing light from target symbols on products;

FIG. 2 is a schematic block diagram of various components of an imaging reader used in the reader of FIG. 1;

FIG. 3 is a diagrammatic perspective view of various components of an imaging reader depicting an offset aiming light pattern on a target in accordance with the prior art;

FIG. 4 is a diagrammatic perspective view analogous to FIG. 3 of one embodiment in accordance with the present invention;

FIG. 5 is a diagrammatic side elevational view of a detail of the embodiment of FIG. 4;

FIG. 6 is a view analogous to FIG. 5 of another detail of the embodiment in accordance with the present invention; and

FIG. 7 is a view analogous to FIG. 5 of yet another detail of the embodiment in accordance with the present invention.

### DETAILED DESCRIPTION OF THE PREFERRED EMBODIMENTS

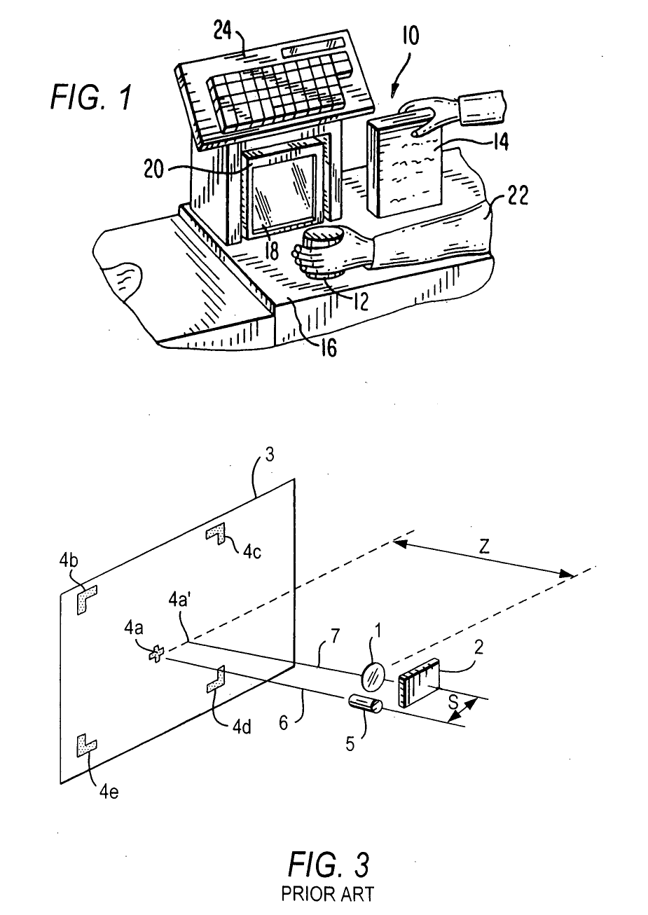

Reference numeral 10 in FIG. 1 generally identifies a workstation for processing transactions and specifically a checkout counter at a retail site at which products, such as a can 12 or a box 14, each bearing a target symbol, are processed for purchase. The counter includes a generally planar support surface or countertop 16 across which the products are slid at a swipe speed past a generally vertical window 18 of a box-shaped, vertical slot, portable imaging reader 20 mounted on the countertop 16 in a hands-free mode of operation. A checkout clerk or operator 22 is located at one side of the countertop, and the imaging reader 20 is located at the opposite side. A cash/credit register 24 is located within easy reach of the operator. In the frequent event that large, heavy, or bulky products, that cannot easily be brought to the reader 20, have target symbols that are required to be read, then the operator 22 may also manually grasp the portable reader 20 and lift it off, and remove it from, the countertop 16 for reading the target symbols in a handheld mode of operation. The reader need not be box-shaped as illustrated, but could have virtually any housing configuration, such as a gun shape.

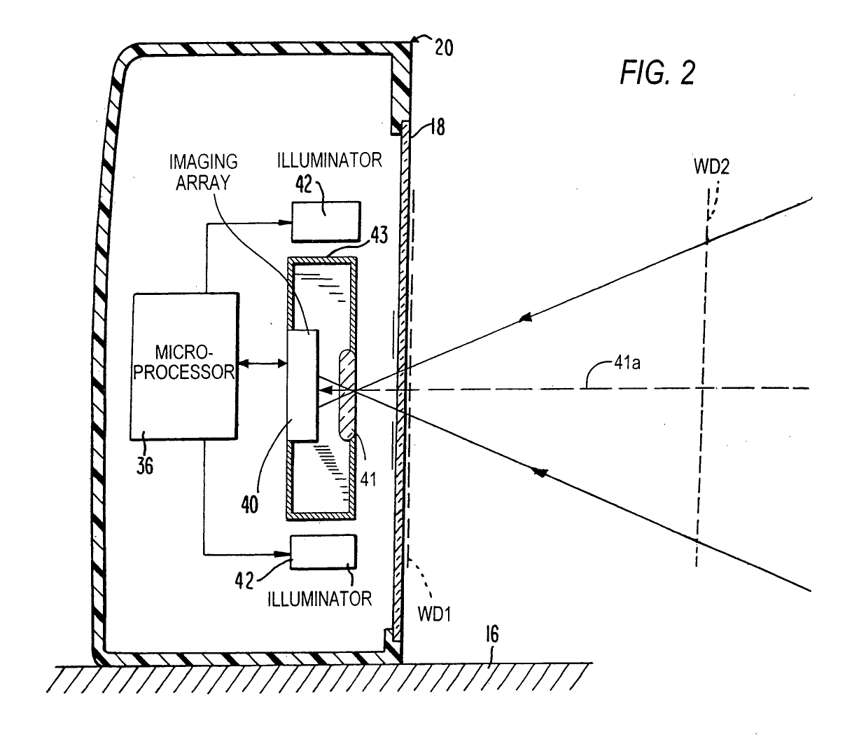

As shown in FIG. 2, the portable imaging reader 20 includes an imager 40 and a focusing lens 41 mounted in an enclosure 43. The imager or imaging array 40 is a solid-state device, for example, a CCD or a CMOS imager and has a one- or two-dimensional array of addressable image sensors operative for capturing return light through the window 18 from a target, e.g., a one-dimensional symbol, a two-dimensional symbol, a document, a person, etc., over a field of view and located anywhere in a working range of distances between a close-in working distance (WD1) and a far-out working distance (WD2). The focusing lens 41 focuses the return light onto the imager and has an imaging axis 41a. Typically, WD1 is about two inches from the imager 40 and generally coincides with the window 18, and WD2 is about eight inches from the window 18. A suitable imager is disclosed in U.S. Pat. No. 5,965,875. An illuminator 42 is also mounted in the reader and includes one light source and preferably a plurality of light sources, e.g., light emitting diodes (LEDs) arranged around the imager 40 to uniformly illuminate the target.

As also shown in FIG. 2, the imager 40 and the illuminator 42 are operatively connected to a controller or programmed microprocessor 36 operative for controlling the operation of these components. Preferably, the microprocessor is the same as the one used for decoding light scattered from the target symbol and for processing the captured target images.

In operation, the microprocessor 36 sends a command signal to the illuminator 42 to pulse the LEDs for a short time period of 500 microseconds or less, and energizes the imager 40 to collect light from a target substantially only during said time period. A typical array needs about 33 milliseconds to read the entire target image and operates at a frame rate of about 30 frames per second. The array may have on the order of one million addressable image sensors.

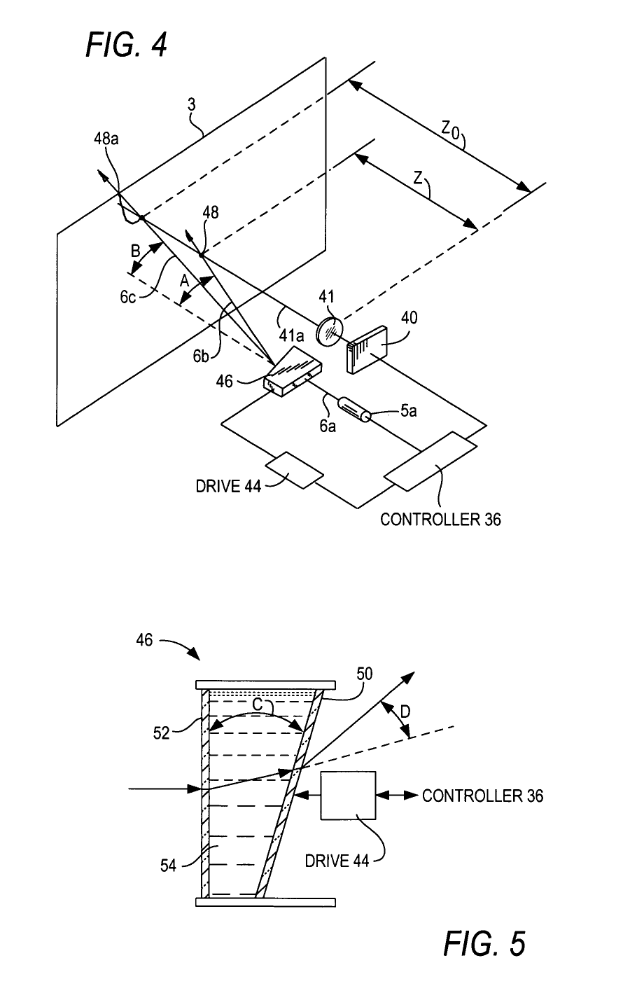

FIG. 4 shows a first embodiment of the reader 20 in which an imaging system includes the solid-state imager 40 and the imaging lens 41 for imaging the light from the target symbol 3 onto the imager 40 along the imaging axis 41a substantially centered in the field of view. The imaging system, under the control of the controller 36, is operative for capturing light from the symbol 3 during reading in the range of working distances over the field of view.

The reader 20 also has an aiming system that includes an aiming light pattern generator 5a, under the control of the controller 36, for visually illuminating the symbol 3 during aiming with an aiming light pattern substantially centered on an aiming axis 6a. The aiming light pattern generator 5a includes a light source, especially a laser, and utilizes an interferometric optical element, such as a diffractive optical element (DOE), a holographic element, or a Fresnel element, or a non-interferometric optical element, such as a lens, or a refractive optical element (ROE) having a plurality of refractive structures. As previously explained in the description of the prior art of FIG. 3, the offset between the aiming axis and the imaging axis results in the parallax S, which the present invention seeks to reduce, if not eliminate.

In accordance with one aspect of this invention, a steering system 44, 46 is operative for steering at least one of the aiming light pattern and the field of view to be substantially aligned with respect to each other throughout the range of working distances. Thus, the aiming light pattern can be steered to be substantially centered in the field of view, or the field of view can be steered to be substantially centered in the aiming light pattern, or both the aiming light pattern and the field of view can be steered until they are in mutual substantial alignment. This steering enables the operator to accurately aim the reader 20 at the symbol 3 that can be located anywhere within the range of working distances prior to reading. As shown in FIG. 4, the steering system 44, 46 is operative for moving the aiming light pattern, preferably a single light spot 48, through an angle A until the aiming axis 6b substantially intersects the imaging axis 41a at each working distance, for example, at the working distance Z. At another working distance Z₀, the steering system 44, 46 moves the single corresponding light spot 48a, through an angle B until the corresponding aiming axis 6c substantially intersects the imaging axis 41a.

The steering system 44, 46, under the control of the controller 36, is operative for controlling the imaging system to acquire an image of the aiming light pattern 48 during aiming to generate a control signal, and for steering the aiming light pattern 48 in response to the control signal. During aiming, which is performed prior to reading, the imager 40 acquires at least one image, and preferably a plurality of successive images, of the aiming light pattern 48, and the controller 36 processes the acquired image(s) to determine the location of the acquired image(s) relative to a known center of the imager 40 on the imaging axis. The imager preferably searches for a bright spot in the aiming pattern. A distance detector can also be used. Knowing the location of the acquired image(s), the controller 36 conducts the control signal as an active feedback signal to a drive 44, as explained below, to steer the aiming light pattern 48 through the corresponding angles A, B.

In accordance with one embodiment of this invention, as shown in FIGS. 4-5, the steering system includes a wedge-shaped cell 46 filled with an optically transparent liquid 54 and bounded by a light-transmissive entrance window 52 and a light-transmissive exit window 50, the windows being oriented at a window angle C relative to each other. The aiming light pattern passes through, and is refracted in, the cell 46 at an angle of refraction D. The drive 44 is operative for changing the window angle C and, in turn, the angle of refraction B in response to the control signal by an electrical and/or mechanical mechanism, for example, an electrical stepping motor or a voice coil driver.

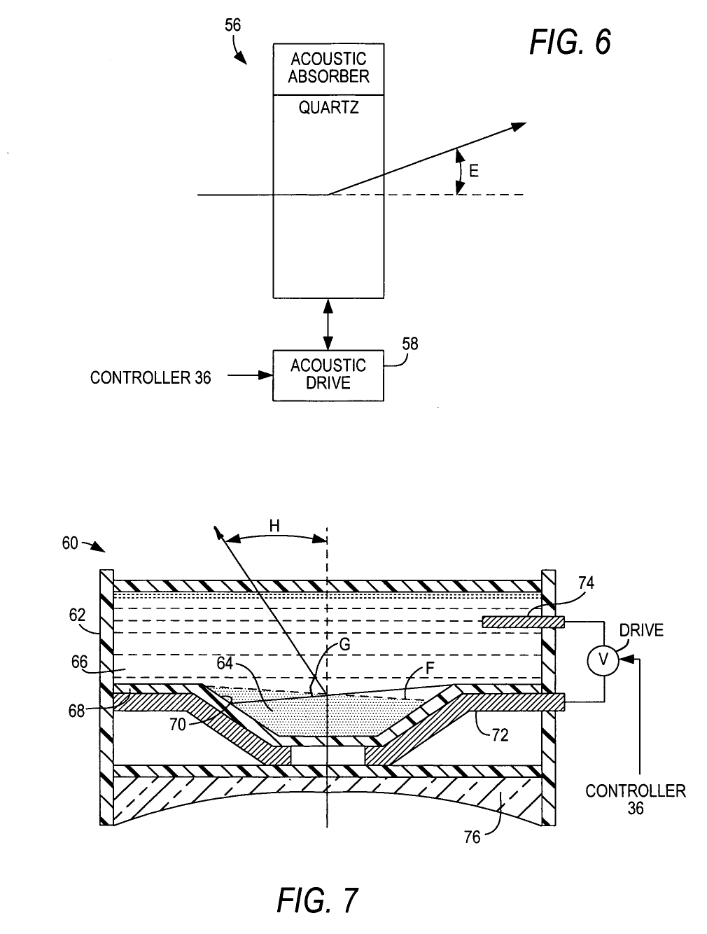

In accordance with another embodiment of this invention, as shown in FIG. 6, the steering system includes an acousto-optical light deflector 56 through which the aiming light pattern passes at a deflection angle E. An acoustic drive 58 is operative for changing the deflection angle E in response to the control signal. The deflector 56, also called a Bragg cell, uses the acousto-optic effect to diffract and shift the frequency of light using sound waves (usually at radio-frequency). The drive 58 is a piezoelectric transducer attached to a material such as quartz or glass. An oscillating electric signal drives the transducer 58 to vibrate, which creates sound waves in the quartz/glass material. These can be thought of as moving periodic planes of expansion and compression that change the index of refraction. The incoming aiming light pattern scatters off the resulting periodic index modulation, and interference occurs similar to Bragg diffraction. A diffracted aiming light pattern emerges into several orders, for example, the first diffraction order emerges at the angle E that depends on the wavelength of the light relative to the wavelength of the sound. The amount of light diffracted by the sound wave depends on the intensity of the sound.

In accordance with yet another embodiment of this invention, as shown in FIG. 7, the steering system includes a variable liquid electrowetting element 60 having a housing 62 in which a first liquid 64 and a second liquid 66 are arranged along an optical path. The liquids 64, 66 are light-transmissive, immiscible, of different optical indices of refraction, and of substantially the same density. The liquid 64 is constituted of an electrically insulating substance. For example, an oil, an alcane, or a blend of alcanes, preferably halogenated, or any other insulating liquid may be used for the liquid 64. The liquid 66 is constituted of an electrically conductive substance, for example, water loaded with salts (mineral or other), or any other liquid, organic or not, and preferably made conductive by the addition of ionic components.

The housing 62 is constituted of an electrically insulating, light-transmissive, material, such as glass, preferably treated with silane or coated with a fluorinated polymer, or a laminate of fluorinated polymer, epoxy resin and polyethylene. The housing 62 includes a dielectric wall 68, preferably having a well 70 in which the liquid 64 is accommodated. The wall 68 normally has a low wetting characteristic compared to the liquid 64, but a surface treatment insures a high wetting characteristic and maintains a centered position of the liquid 64 and prevents the liquid 64 from spreading. The well 70 further helps to prevent such spreading. A lens 76 may be provided along the optical path.

A first electrode 74 extends into the liquid 66, and a second electrode 72 is located below the wall 68. The electrodes are connected to a drive or voltage source V. The electrodes, especially electrode 72, are preferably light-transmissive. When a voltage is applied across the electrodes, an electrical field is created which alters the wetting characteristic of the wall 68 with respect to the liquid 64. The wetting increases substantially in the presence of an electrical field.

With no voltage applied, the liquid 64 takes the shape shown in solid lines in FIG. 7, and its outer surface “F” lies in a plane generally inclined in one direction. When a voltage is applied, the wetting of the dielectric wall 68 increases, and the liquid 64 deforms and takes the shape shown in dashed lines in FIG. 7, and its outer surface “G” lies in a plane generally inclined in an opposite direction. This deformation of the liquid 64 is employed by the present invention to steer the aiming light pattern and deflect it at an angle H.

Although the steering element, e.g., 46 in FIG. 4, is illustrated as being in the path of the aiming system to steer the aiming light pattern, this invention is not intended to be limited thereby, because each steering element 46, 56, 60 could equally well and, in some cases, preferably be located in the path of the imaging system to steer the field of view. This enables the aiming light pattern to be stationary, which may be preferred for some operators since the aiming light pattern does not move around during use. With this approach, the steering element must be of a higher quality, so as to avoid introducing aberrations into the images.

It will be understood that each of the elements described above, or two or more together, also may find a useful application in other types of constructions differing from the types described above.

While the invention has been illustrated and described as embodied in compensating for parallax in an imaging reader and method, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims:

1. An imaging reader for electro-optically reading a symbol located in a range of working distances from the reader, comprising:
an imaging system including a solid-state imager having an array of image sensors for capturing light from the symbol in the range of working distances over a field of view;
an aiming system including an aiming light pattern generator for visually illuminating the symbol with an aiming light pattern; and
a steering system for steering at least one of the aiming light pattern and the field of view to be substantially aligned relative to each other throughout the range of working distances to aid an operator in aiming the imager at the symbol prior to reading.

2. The reader of claim 1, wherein the imaging system includes an imaging lens for imaging the light from the symbol onto the imager along an imaging axis substantially centered in the field of view, wherein the aiming system illuminates the symbol along an aiming axis substantially centered in the aiming light pattern, and wherein the steering system is operative for moving the at least one of the aiming light pattern and the field of view until the aiming axis substantially intersects the imaging axis at each working distance.

3. The reader of claim 1, wherein the steering system includes a controller operatively connected to the imaging and the aiming systems, for controlling the imaging system to acquire an image of the aiming light pattern to generate a feedback control signal, and for steering the at least one of the aiming light pattern and the field of view in response to the feedback control signal.

4. The reader of claim 3, wherein the controller is also operative for processing the light captured from the symbol into data relating to the symbol.

5. The reader of claim 3, wherein the steering system includes a liquid-filled cell bounded by windows oriented at an window angle relative to each other, and wherein the at least one of the aiming light pattern and the field of view passes through and is refracted in the cell at an angle of refraction, and a drive for changing the window angle and, in turn, the angle of refraction in response to the feedback control signal.

6. The reader of claim 3, wherein the steering system includes an acousto-optical light deflector through which the at least one of the aiming light pattern and the field of view passes at a deflection angle, and an acoustic drive for changing the deflection angle in response to the feedback control signal.

7. The reader of claim 3, wherein the steering system includes a variable liquid electrowetting element through which the at least one of the aiming light pattern and the field of view passes at a deflection angle, and a voltage drive for changing the deflection angle in response to the feedback control signal.

8. The reader of claim 1, wherein the aiming light pattern comprises a visible mark substantially centered in the aiming light pattern.

9. An imaging reader for electro-optically reading a symbol located in a range of working distances from the reader, comprising:
imaging means for capturing light from the symbol in the range of working distances over a field of view;
aiming means for visually illuminating the symbol with an aiming light pattern; and
steering means for steering at least one of the aiming light pattern and the field of view to be substantially aligned relative to each other throughout the range of working distances to aid an operator in aiming the imaging means at the symbol prior to reading.

10. The reader of claim 9, wherein the imaging means is operative for imaging the light from the symbol along an imaging axis substantially centered in the field of view, wherein the aiming means illuminates the symbol along an aiming axis substantially centered in the aiming light pattern, and wherein the steering means is operative for moving the at least one of the aiming light pattern and the field of view until the aiming axis substantially intersects the imaging axis at each working distance.

11. The reader of claim 9, wherein the steering means is operative for controlling the imaging means to acquire an image of the aiming light pattern to generate a feedback control signal, and for steering the at least one of the aiming light pattern and the field of view in response to the feedback control signal.

12. A method of electro-optically reading a symbol located in a range of working distances from an imaging reader, comprising the steps of:
capturing light from the symbol in the range of working distances with a solid-state imager having an array of image sensors over a field of view;
visually illuminating the symbol with an aiming light pattern generated by an aiming system; and
steering at least one of the aiming light pattern and the field of view to be substantially aligned relative to each other throughout the range of working distances to aid an operator in aiming the imager at the symbol prior to reading.

13. The method of claim 12, wherein the capturing light step is performed by imaging the light from the symbol onto the imager along an imaging axis substantially centered in the field of view, wherein the illuminating step is performed by illuminating the symbol along an aiming axis substantially centered in the aiming light pattern, and wherein the steering step is performed by moving the at least one of the aiming light pattern and the field of view until the aiming axis substantially intersects the imaging axis at each working distance.

14. The method of claim 12, wherein the steering step is performed by controlling the imager to acquire an image of the aiming light pattern to generate a feedback control signal, and by steering the at least one of the aiming light pattern and the field of view in response to the feedback control signal.

15. The method of claim 14, and processing the light captured from the symbol into data relating to the symbol.

16. The method of claim 14, wherein the steering step is performed by a liquid-filled cell bounded by windows oriented at an window angle relative to each other, and passing the at least one of the aiming light pattern and the field of view through, and refracting the at least one of the aiming light pattern and the field of view in, the cell at an angle of refraction, and changing the window angle and, in turn, the angle of refraction in response to the feedback control signal.

17. The method of claim 14, wherein the steering step is performed by an acousto-optical light deflector through which the at least one of the aiming light pattern and the field of view passes at a deflection angle, and changing the deflection angle in response to the feedback control signal.

18. The method of claim 14, wherein the steering step is performed by a variable liquid electrowetting element through which the at least one of the aiming light pattern and the field of view passes at a deflection angle, and changing the deflection angle in response to the feedback control signal.

19. The method of claim 12, and configuring the aiming light pattern with a visible mark substantially centered in the aiming light pattern.

20. The method of claim 12, and configuring the aiming light pattern with a visible center mark substantially centered in the aiming light pattern and visible corner marks that frame corners of the aiming light pattern.
